(19) United States
(12) Patent Application Publication
(10) Pub. No.: US 2025/0136448 A1
(43) Pub. Date: May 1, 2025

(54) METHOD FOR CARBONIZING A POLYMER AND A GRAPHITE PREPARED BY THE SAME

(71) Applicants: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(72) Inventors: Jin Gi Ahn, Seoul (KR); Tae Hee Han, Seoul (KR); Woo Jae Jeong, Seoul (KR)

(73) Assignees: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(21) Appl. No.: 18/602,304

(22) Filed: Mar. 12, 2024

(30) Foreign Application Priority Data
Nov. 1, 2023 (KR) 10-2023-0149362

(51) Int. Cl. C01B 32/205

(52) U.S. Cl. CPC C01B 32/205

(57) ABSTRACT

A method for carbonizing a polymer and a graphite prepared by the method are disclosed. The method includes a stabilization treatment operation of treating a polyolefin-based polymer with an acid solution containing at least one of hydrochloric acid, nitric acid, or a combination thereof. The method also includes a carbonization treatment operation of carbonizing the stabilized polymer at a temperature within a range of 400 to 3350° C. The graphite obtained therefrom is soft carbon.

### CROSS-REFERENCE TO RELATED APPLICATION

This application claims the benefit of priority to Korean Patent Application No. 10-2023-0149362 filed on Nov. 1, 2023 in the Korean Intellectual Property Office, the disclosure of which is incorporated herein by reference in its entirety.

### TECHNICAL FIELD

The present disclosure relates to a method for carbonizing a polymer, and more specifically, to a process in which a polymer waste is manufactured into high crystalline carbon. According to the present disclosure, soft carbon may be obtained.

### BACKGROUND

Since the Industrial Revolution, the generation of numerous types of waste has been accelerating around the world. Among such waste, incineration and landfill are the main methods for processing polymer waste. However, there is a problem in that carbon dioxide (CO₂) generated during the process may promote global warming.

Due to this problem, there is a phenomenon of exporting and importing carbon credits and waste from developed countries to developing and underdeveloped countries. However, this phenomenon may not be a solution to fundamental environmental pollution and is only a temporary solution to problems within a country or, on a smaller scale, a local community. The fundamental method to solve the problem is to regulate polymers, but polymers have already become a necessity in human society.

Therefore, although research into recycling polymers is being conducted, mainly in developed countries, polymer waste, i.e., waste plastic, is difficult to be recycled and is not used as a raw material for new products. This is because recycled polymers do not realize original properties of the polymer. Accordingly, mechanical recycling limited to clean plastics is partially performed, but the plastics thus obtained are generally used in low-level application fields.

Meanwhile, research and development are being conducted to create a high-added value product through upcycling rather than recycling, but the degree of progress insignificant. Since most polymers are organic is still substances of which a backbone is connected to carbon, the polymers may be manufactured into various carbon materials such as bio-char, hydrocarbon, activate carbon, and the like, through a process of removing elements other than carbon under an inert gas using high heat and pressure. However, the carbon materials have very limited uses due to numerous voids inside the carbon structure. For example, Korea Publication No. 10-2018-0083155 discloses a method for manufacturing artificial graphite using waste containing carbon materials. However, research on manufacturing carbon materials using a polymer waste as a starting material is insignificant.

Therefore, if a technology for manufacturing high crystalline carbon, such as graphite, using a polymer, for example, a polymer waste, is provided, it is expected to be widely used in related fields.

### SUMMARY

An aspect of the present disclosure is to provide a method in which a polymer may be manufactured into a high crystalline carbon material through stabilization and heat treatment processes.

Another aspect of the present disclosure is to provide graphite obtained from a polymer.

According to an aspect of the present disclosure, a method for carbonizing a polymer is provided. The method includes a stabilization treatment operation of treating a polyolefin-based polymer with an acid solution containing at least one of hydrochloric acid, nitric acid, or a combination thereof. The method also includes a carbonization treatment operation of carbonizing the stabilized polymer at a temperature within a range of 400 to 3350° C.

According to another aspect of the present disclosure, soft carbon having a graphite-like structure is formed, which is obtained by the method for carbonizing a polymer of the present disclosure.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 illustrates results of x-ray diffraction (XRD) analysis of a size of carbon crystals obtained after performing a stabilization process and carbonization process for a polymer, where view (a) schematically illustrates a stacking height (Lc) and a lateral size (La), and view (b) illustrates the results of XRD analysis.

FIG. 2 illustrates I_{D1}/I_{G} and I_{D3}/I_{G} of carbon crystals obtained after performing a stabilization process and carbonization process for a polymer as a result of Raman analysis.

FIG. 3 illustrates the tendency of weight loss of a polymer due to thermal decomposition as a temperature increases when a stabilization process is omitted.

FIG. 4, views (a) and (b), illustrate a change in maximum carbon yield (%) according to a temperature change in a stabilization process for a polymer.

FIG. 5 view (a) illustrates results of analyzing a chemical structure of low-density polyethylene (LDPE) stabilized at each temperature through FT-IR analysis by changing a temperature of a stabilization process for a polymer from 150° C. to 300° C. and view (b) schematically illustrates the chemical structure of LDPE according to each stabilization temperature.

FIG. 6 illustrates a change in an internal structure of a carbide after performing a carbonization process according to a temperature change in a stabilization process for a polymer, where view (a) illustrates the results when the stabilization temperature is 150° C., view (b) illustrates the results when the stabilization temperature is at a temperature within a range of exceeding 150° C. to 250° C., view (c) illustrates the results when the stabilization temperature is 300° C., and view (d) schematically illustrates a graphite layer obtained from view (c).

FIG. 7 illustrates XRD measurement results in view (a) and Raman shift in view (b) for a carbonized resulting product when carbonized under temperature conditions of a carbonization process at a temperature increase rate of 3° C./min.

FIG. 8 illustrates the results of carbonizing waste polymers according to an embodiment of the present disclosure.

### DETAILED DESCRIPTION

Hereinafter, embodiments of the present disclosure are described with reference to the attached drawings. However, the embodiments of the present disclosure may be modified into various other forms and the scope of the present disclosure is not limited to the embodiments described below.

According to the present disclosure, a method for carbonizing a polymer including a stabilization treatment operation is provided.

In the present disclosure, through carbonization, soft carbon, which is particularly graphitizable carbon, may be obtained. According to the present disclosure, high crystalline carbon, for example, graphite may be included.

In more detail, the method for carbonizing a polymer of the present disclosure includes a stabilization treatment operation of treating a polyolefin-based polymer with an acid solution containing at least one of hydrochloric acid, nitric acid, or a combination thereof. This yields a stabilized polymer. The method also includes a carbonization treatment operation of carbonizing the stabilized polymer at a temperature within a range of 400 to 3350° C.

The polyolefin-based polymer to which the present disclosure may be applied may be at least one polymer selected from a group comprising or consisting of low-density polyethylene, high-density polyethylene, polypropylene, of any combination thereof. For example, the polyolefin-based polymer may be a polymer waste comprising or consisting of at least one selected from a group comprising low-density polyethylene, high-density polyethylene, polypropylene, or any combination thereof. In more detail, the polymer of the present disclosure is intended to include all agricultural, industrial, and household olefin-based polymers, low molecules, and single molecules among plastic waste, and includes all olefin-based polymer wastes containing plasticizers, dyes, and the like.

For such polymers, in the method for carbonizing a polymer of the present disclosure, a stabilization treatment operation of treating a polyolefin-based polymer with an acid solution containing at least one of hydrochloric acid or nitric acid before the carbonization step is first performed before the carbonization operation.

In this case, the acid solution may contain at least one of hydrochloric acid or nitric acid. For example, the acid solution may be a mixed acid solution containing hydrochloric acid and nitric acid. The mixed acid solution may contain hydrochloric acid and nitric acid in a molar ratio of 1:1. The pH of the acid solution applied to the present disclosure may be in a range of −1.1 to 5.

The stabilization treatment operation of treating with an acid solution may be performed at a temperature within a range of 150° C. or higher and lower than 320° C. The stabilization treatment operation may be performed, for example, at a temperature within a range of exceeding 250° C. and lower than 320° C. or, for example, at a temperature of 280° C. to 320° C. The stabilization treatment operation may be performed for 10 minutes to 24 hours under an air atmosphere.

When the stabilization operation of the present disclosure is not performed, carbon yield rapidly decreases after performing a carbonization treatment. Even when the temperature of the stabilization operation is 250° C. or lower, there is a problem in that the carbon yield becomes insufficient at 45% or less. Meanwhile, when the temperature of the stabilization operation is 320° C. or higher, rapid thermal decomposition of the polymer may occur. When the stabilization operation is performed at a temperature within the range of the present disclosure, a resulting product in which the polymer is manufactured into high crystalline carbon may be obtained with improved yield.

After performing the stabilization operation, a carbonization treatment operation is performed in which the stabilized polymer is carbonized at a temperature within a range of 400 to 3350° C. The carbonization treatment temperature may be, for example, 800 to 2700° C.

Meanwhile, the temperature of the carbonization treatment operation may be increased at a temperature increase rate of 1° C./min or more and less than 10° C./min. For example, the carbonization treatment operation may be increased at a temperature increase rate of 2° C./min to 7° C./min. When the temperature increase rate in the carbonization treatment operation is less than 1° C./min, a processing time may be long. When the temperature increase rate in the carbonization treatment operation exceeds 10° C./min, a hexagonal structure formed by six carbon atoms is not formed and is grown in a form without orientation due to rapid temperature increase. Thus, hard carbon may be obtained.

That is to say, the carbonization operation of the present disclosure is an operation of producing soft carbon.

In this case, the carbonization treatment operation may be performed under an air atmosphere for 10 minutes to 24 hours.

The carbonization operation may be performed at a temperature within a range of 2500 to 3350° C. and may be performed as a graphitization operation to obtain soft carbon. For example, the carbonization operation may be performed at a temperature within a range of 2700 to 3000° C.

According to another aspect of the present disclosure, soft carbon may be obtained by the method for carbonizing a polymer of the present disclosure.

Soft carbon obtained by the present disclosure has a graphite-like structure, which is obtained as a result of carbonizing a polymer. Since soft carbon has efficient transfer of electrons and electrical and thermal conductivity, soft carbon may be used in various industrial fields such as electrons, semiconductors, energy storage devices, and the like.

Hereinafter, the present disclosure is described in more detail through specific examples. The following examples are merely examples to aid in understanding the present disclosure. The scope of the present disclosure is not limited thereto.

### Example

### 1. Polymer to be Applied to a Method for Carbonizing Polymer

Polyethylene (PE), polypropylene (PP), polyethylene terephthalate (PET), polystyrene (PS), and polyvinyl chloride (PVC) were heat treated at a temperature within a range of 550 to 900° C. The resulting carbon yield obtained therefrom was determined and is shown in Table 1 below.

TABLE 1

| Type of | Content of carbon | Carbon yield (@ temperature for |
|---|---|---|
| polymers | (wt %) | measuring carbon yield) |
| PE | 85.7 | 72-75 @ 900° C. |
| PP | 85.7 | 50.3 @ 700° C. |
| PET | 62.5 | 19-21 @ 750° C. |
| PS | 92.3 | 40 @ 900° C. |
| PVC | 38.4 | 16-20 @ 550° C. |

As can be seen in Table 1, olefinic-based polymers including PE and PP have a simple structure having a single combination between carbon atoms. Furthermore, it was confirmed that the carbon yield was the highest after performing a high-temperature heat treatment.

### 2. Carbonization Process of Polymer

### (1) Stabilization Process

Low-density polyethylene (LDPE), high-density polyethylene (HDPE), and PP were subjected to a stabilization process by performing an acid treatment or thermal oxidation as follows.
\textcircled{1} HN (Hydrothermal): 10 g of each polymer was treated with 20 g of a mixed acid solution in which 5 mol of an aqueous hydrochloric acid and 5 mol of an aqueous nitric acid were mixed at a molar ratio of 1:1 for 12 hours under air conditions.
\textcircled{2} S (Hydrothermal): 10 g of each polymer was treated with 20 g of 95% of a sulfuric acid aqueous solution for 12 hours under air conditions.
\textcircled{3} Air (Air heat treatment): 10 g of each polymer was treated for 12 hours at a temperature of 10° C. under an air atmosphere.

### (2) Carbonization Process

Each sample having undergone the stabilization process in 2. (1) as above was carbonized by heating the sample for 1 hour at a temperature of 900° C. at a temperature increase rate of 5° C./min under an air atmosphere.

### 3. Determine Physical Properties of Carbide

### (1) Determine Size of Carbon Crystals According to Process Conditions

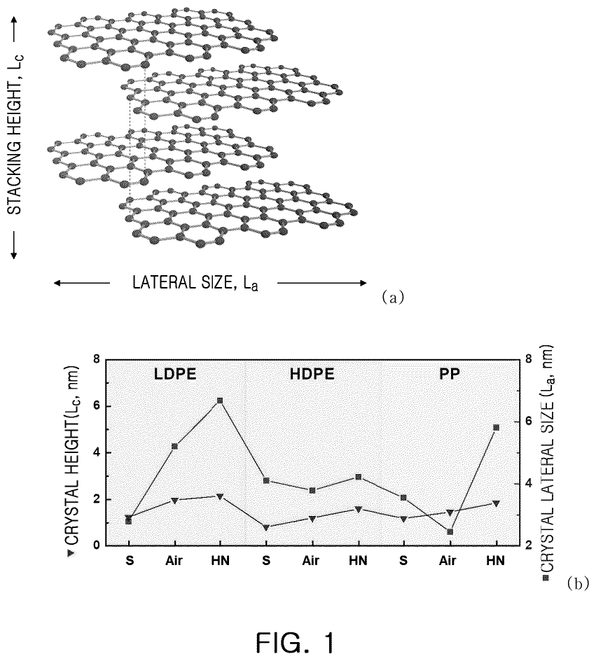

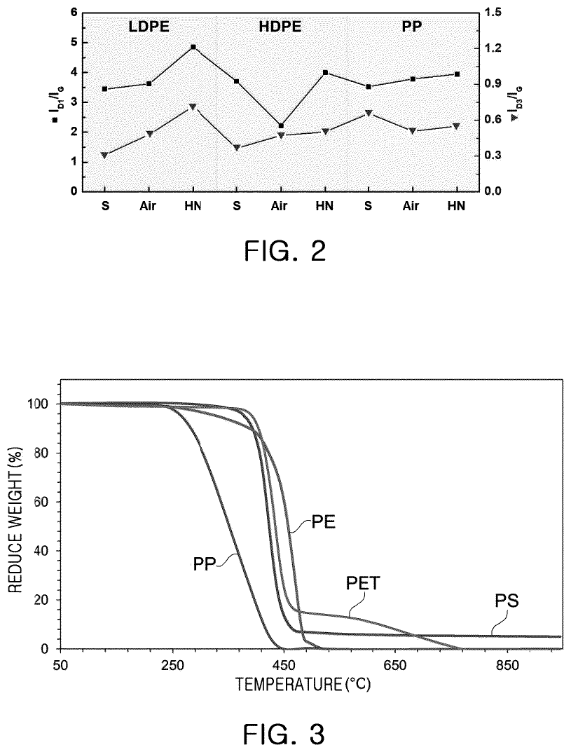

A size of the carbon crystals obtained after performing the stabilization process in each process \textcircled{1} to \textcircled{3} in 2, and the carbonization process of polymers at a temperature of 900° C. described above were confirmed through x-ray diffraction (XRD) analysis and Raman analysis. The results thereof were shown in FIG. 1 and FIG. 2, respectively.

In more detail, as a result of the XRD analysis, a stacking height (Lc) and a lateral size (La) as schematically shown in FIG. 1, view (a), were measured. The results thereof were shown in FIG. 1, view (b).

In addition, as a result of Raman analysis, I_{D1}/I_{G} of a disordered graphite layer and I_{D3}/I_{G} of an amorphous carbon layer are shown in FIG. 2. In the disordered graphite layer, I_{D1} represents a peak intensity of the disordered graphite layer generating from plane vibration and I_{G} refers to a peak intensity of a graphite structure occurring due to internal vibrations of a C—C bond from an sp2 orbital. Also, in the amorphous carbon layer, I_{D1} represents a peak intensity of the amorphous graphite layer generating from plane vibration and I_{G} refers to a peak intensity of the graphite structure occurring due to the internal vibrations of the C—C bond from the sp2 orbital. In FIG. 2, a ratio of the I_{D1}/I_{G} and I_{D3}/I_{G} increases, which means a graphene structure grows in in-plane and out-of-plane directions of the structure. Specifically, t was confirmed that polyolefin-based polymers, having an existing linear structure by receiving sufficient oxygen through the stabilization process, changed more to a cyclic ladder structure through the HN treatment.

As a result of determining carbon crystals as described above, it was confirmed that high crystalline carbon may be manufactured most effectively through the stabilization process using the HN treatment method.

The stabilization and carbonization process conditions and resulting analysis results are summarized in Table 2 below.

TABLE 2

| | | Stabilization | Carbonization | | | | |
|---|---|---|---|---|---|---|---|
| | | temperature/ | temperature/ | | | | |
| | Stabilization | Temperature | Temperature | | | | |
| | treatment | increase rate/ | increase rate/ | | | | |
| Polymer | method | Environment | Environment | L_{c} (nm) | Lₐ (nm) | I_{D1}/I_{G} | I_{D3}/I_{G} |
| LDPE | HN | 150° C./ | 900° C./ | 2.13 | 6.68 | 4.86 | 0.72 |
| | S | 5° C./min/ | 5° C./min/ | 1.22 | 2.78 | 3.44 | 0.31 |
| | Air | Air condition | Air condition | 1.96 | 5.19 | 3.62 | 0.48 |
| HDPE | HN | | | 1.58 | 4.21 | 3.99 | 0.50 |
| | S | | | 0.80 | 4.10 | 3.71 | 0.36 |
| | Air | | | 1.19 | 3.78 | 2.22 | 0.47 |
| PP | HN | | | 1.84 | 5.80 | 3.95 | 0.65 |
| | S | | | 1.17 | 3.54 | 3.52 | 0.57 |
| | Air | | | 1.44 | 2.45 | 3.78 | 0.51 |

### (2) Comparative Experiment Example—Impact of Omitting Stabilization Process

In order to determine carbonization results when only a carbonization process was performed at a temperature of 900° C. without performing the stabilization process, 5 g of each sample of PS, PE, and PP was carbonized at 5° C./min under an inert argon (Ar) gas condition without performing the stabilization process and the temperature was increased to a temperature of 900° C. or higher at a temperature increase rate of 5° C./min.

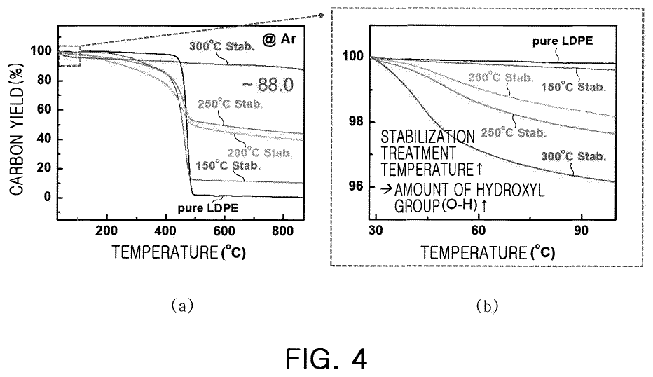

As a result thereof, as can be seen in FIG. 3, it was confirmed that the polyolefin-based polymer was entirely decomposed into gas at a temperature between 45° and 500° C., and the carbon yield was 0%.

### (3) Determine Impact of Stabilization Process Temperature

As confirmed in 3. (2) described above, performing a stabilization process is an essential operation in the present disclosure. Furthermore, in order to determine the impact of temperature during the stabilization process, when performing the stabilization process by HN and the carbonization process at a temperature of 900° C., the impact thereof was confirmed by changing the temperature of the stabilization process from 150° C. to 300° C.

### 1) Determine Carbon Yield

While changing the temperature of the stabilization process from 150° C. to 300° C., a change in maximum carbon yield (%) was analyzed through TGA analysis. The results thereof were shown in Table 3 and FIG. 4 below.

Carbon yield is confirmed by weight loss (%) in a TGA graph. A general organic-inorganic thermogravimetric analysis (TGA) graph is drawn with an X-axis indicating a temperature and a Y-axis indicating weight loss. When the process is performed to a target temperature, information such as an amount remaining after decomposition may be known. Here, the weight loss of the carbon material refers to the carbon yield. When the process is performed to a target temperature, an amount of carbon obtained may be known.

TABLE 3

| Stabilization | Carbon |
|---|---|
| temperature (° C.) | yield (%) |
| 100 | 0.1 |
| 150 | 10.3 |
| 200 | 39.5 |
| 250 | 44.2 |
| 300 | 88.0 |

As a result thereof, it was confirmed that the stabilization process by HN performed at a temperature of 300° C. showed high carbon yield of approximately 88.0%. FIG. 4, view (a), shows the results of Table 3 in a graph, and FIG. 4, view (b), is an enlarged graph while the temperature ranges from 30° C. to 90° C. This means that as the temperature of the stabilization process increases, surface hydroxyl (—OH) groups are generated and the surface becomes hydrophilic.

Meanwhile, it was confirmed that LDPE undergoes rapid thermal decomposition in air at temperatures exceeding a temperature of 320° C. Thus, the stabilization process of the present disclosure was performed at a temperature of 320° C. or lower, for example, at a temperature of 300° C.

### 2) Chemical Structure Analysis

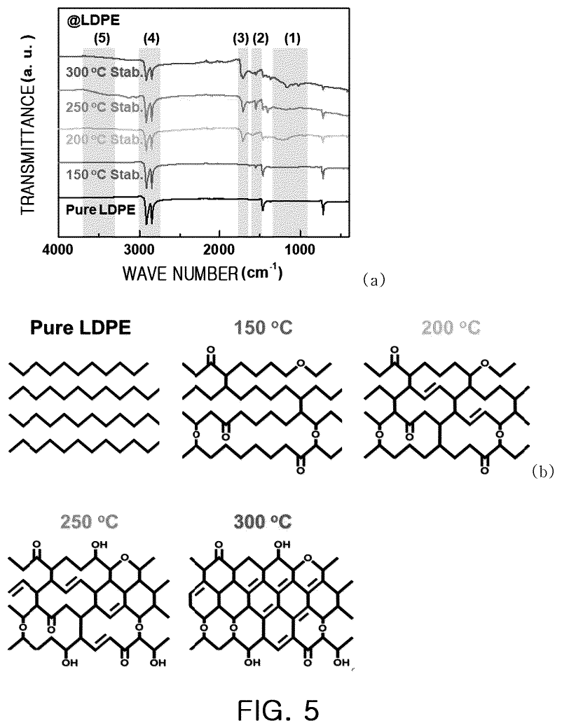

While changing the temperature of the stabilization process from 150° C. to 300° C., a chemical structure of the stabilized LDPE at each temperature was analyzed through Fourier transform infrared spectroscopy (FT-IR) analysis. The results thereof were shown in FIG. 5, view (a). In FIG. 5, view (a), (1) to (5) correspond to the substituents and wave numbers below.

$$( 1 ) \begin{matrix}C - O & 820 \sim 1200 {cm}^{- 1}\end{matrix}$$

$$( 2 ) \begin{matrix}C = C & \sim\end{matrix} 1600 {cm}^{- 1}$$

$$( 3 ) \begin{matrix}C = O & \sim\end{matrix} 1700 {cm}^{- 1}$$

$$( 4 ) \begin{matrix}C - H & \sim\end{matrix} 2800 {cm}^{- 1}$$

$$( 5 ) \begin{matrix}O - H & \sim\end{matrix} 3500 {cm}^{- 1}$$

Meanwhile, FIG. 5, view (b), schematically illustrates the chemical structure according to each temperature.

Summarizing these results, it was confirmed that LDPE treated at a temperature of 300° C. had a stable ladder structure, which is not thermally decomposed in a high-temperature heat treatment.

### 3) Analysis of Internal Structure of Carbide

When performing the stabilization process by HN and the carbonization process at a temperature of 2700° C., a change in an internal structure of a carbide was confirmed through a transmission electron microscope (TEM) after the carbonization process was performed according to a temperature change of the stabilization process.

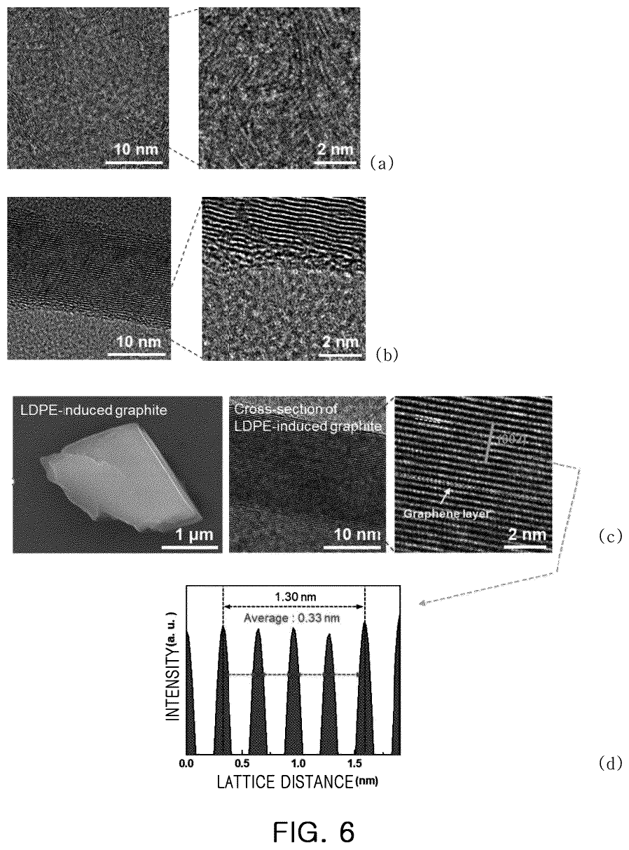

As a result thereof, when the stabilization temperature was 150° C., as can be seen in FIG. 6, view (a), a graphene layer inside the graphite did not grow uniformly. This leads to formation of a porous carbon structure, which may be analyzed to be because a linear structure of ethylene is not composed of a ladder structure, so it is thermally decomposed in gaseous form.

When the stabilization temperature was 150 to 250° C., as can be seen in FIG. 6, view (b), it was confirmed that a uniform high crystalline carbon structure could not be obtained partially due to non-uniform growth of the graphene layer.

Meanwhile, when the stabilization temperature was 300° C., as can be seen in FIG. 6, view (c), it was confirmed that a graphite layer was formed. As schematically shown in FIG. 6, view (d), it was confirmed that the gap was about 0.33 nm on average. In this case, the temperature increase rate was all set at 3° C./min.

### (4) Determine Impact According to Carbonization Process Temperature

An LDPE sample subjected to an HN process during the stabilization process in 2. (1) described above was carbonized by performing a heat treatment for 1 hour at a temperature condition of 400 to 2700° C. at a temperature increase rate of 3° C./min under an Ar atmosphere.

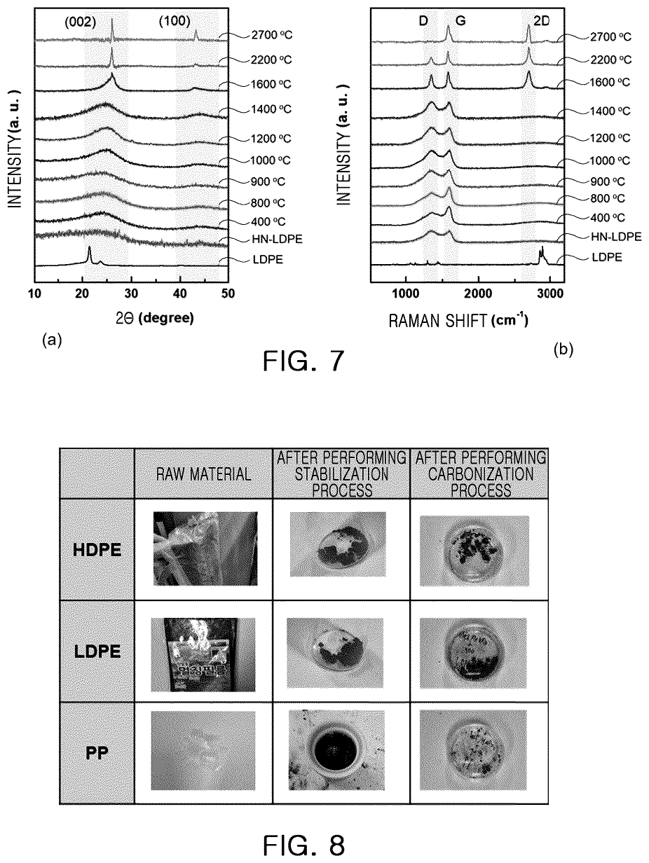

As a result thereof, XRD measurement results were shown in FIG. 7, view (a), and Raman shift was shown in FIG. 7, view (b). Meanwhile, in FIG. 7, views (a) and (b), HN-LDPE refers to LDPE treated at a temperature of 300° C. for 12 hours with a mixed acid solution of 5 mol aqueous hydrochloric acid and 5 mol aqueous nitric acid at a 1:1 molar ratio, and LDPE refers to pure LDPE without any treatment. In the XRD measurement results in FIG. 7, view (a), it was confirmed that, as a heat treatment temperature increases, a peak became sharper. This confirmed that a size of carbon crystals increased as the heat treatment temperature increases. In addition, in the Raman measurement results in FIG. 7, view (b), as the temperature increases, it was confirmed that a D peak, in carbon defects, decreases, and the G and 2D peaks due to crystal growth increase. This confirmed that high crystalline carbon was manufactured at a temperature of 2700° C.

### 4. Carbonization of Waste Polymer

A hydrothermal (HN) stabilization process was performed by treating 20 g of a mixed acid solution in which mol of aqueous hydrochloric acid and 5 mol of aqueous nitric acid are mixed at a molar ratio of 1:1 by securing 10 g of each of HDPE and LDPE, which are agricultural mulching vinyl, and a PP waste, which is a food container and packaging material at a molar ratio of 1:1 at 300° C. for 12 hours.

Thereafter, the stabilized polymer was carbonized by heating the same at a temperature increase rate of 3° C./min at 900° C. for 1 hour under an Ar atmosphere.

As a result thereof, it was confirmed that a graphite carbide could be obtained, as can be seen in FIG. 8.

As set forth above, according to a method for carbonizing a polymer of the present disclosure, a waste polymer may be manufactured into high crystalline carbon. In particular, the carbon material obtained by the present disclosure is soft carbon with carbon orientation and may be used as a carbon material with excellent electron transfer efficiency and thermal conductivity. Therefore, the carbon material obtained by the present disclosure may be used in various industrial fields such as electronics, semiconductors, energy storage devices, and the like. Therefore, the carbon material obtained by the present disclosure may be used in various industrial fields such as electronics, semiconductors, energy storage devices, and the like.

While example embodiments have been illustrated and described above, it should be apparent to those having ordinary skill in the art that modifications and variations could be made without departing from the scope of the present disclosure as defined by the appended claims.

What is claimed is:

1. A method for carbonizing a polymer, the method comprising:
a stabilization treatment operation of treating a polyolefin-based polymer with an acid solution containing at least one of hydrochloric acid, nitric acid, or a combination thereof to produce a stabilized polymer; and
a carbonization treatment operation of carbonizing the stabilized polymer at a temperature within a range of 500 to 3350° C.

2. The method of claim 1, wherein the polyolefin-based polymer is at least one polymer selected from a group comprising low-density polyethylene, high-density polyethylene, polypropylene, or any combination thereof.

3. The method of claim 1, wherein the polyolefin-based polymer is at least one polymer waste selected from a group comprising low-density polyethylene, high-density polyethylene, polypropylene, or any combination thereof.

4. The method of claim 1, wherein the acid solution is a mixed acid solution containing hydrochloric acid and nitric acid.

5. The method of claim 4, wherein the mixed acid solution is a mixed acid solution containing hydrochloric acid and nitric acid at a molar ratio of 1:1.

6. The method of claim 1, wherein the stabilization treatment operation is performed at a temperature within a range of 150° C. or higher and lower than 320° C.

7. The method of claim 1, wherein a temperature of the carbonization treatment operation is increased at a temperature increase rate of 1° C./min or more and less than 10° C./min.

8. The method of claim 1, wherein the stabilization treatment operation is performed for a time period in a range of 30 minutes to 24 hours.

9. The method of claim 1, wherein the carbonization treatment operation is performed for a time period in a range of 10 minutes to 24 hours.

10. The method of claim 1, wherein the stabilization treatment operation and the carbonization treatment operation are performed under an air atmosphere.

11. The method of claim 1, wherein the carbonization treatment operation is performed at a temperature within a range of 400 to 3350° C. to obtain graphite.

12. The method of claim 1, wherein the carbonization treatment operation is manufacturing soft carbon.

13. A graphite material obtained by the method of claim 1, wherein the graphite material is soft carbon.
